(19) United States
(12) Patent Application Publication
(10) Pub. No.: US 2020/0274591 A1
(43) Pub. Date: Aug. 27, 2020

(54) REMOTE RADIO HEAD, BEAMFORMING METHOD AND STORAGE MEDIUM

(71) Applicant: NEC Corporation, Tokyo (JP)

(72) Inventors: Dileep KUMAR, Tokyo (JP); Kazushi MURAOKA, Tokyo (JP); Naoto ISHII, Tokyo (JP)

(73) Assignee: NEC Corporation, Tokyo (JP)

(21) Appl. No.: 16/753,697

(22) PCT Filed: Oct. 4, 2017
(86) PCT No.: PCT/JP2017/036176

§ 371 Date: Apr. 3, 2020

(51) Int. Cl. H04B 7/06; H04W 88/08; H04W 24/08; H04W 16/28

(52) U.S. Cl. CPC H04B 7/0617; H04W 16/28; H04W 24/08; H04W 88/085

(57) ABSTRACT

A RRH has multiple antennas in a wireless communication system. The RRH generates a plurality of analog beams to serve at least one user terminal. The RRH includes a parameter calculator, a metric calculator and a beam former. The parameter calculator is configured to calculate at least one parameter including an un-scanned duration for each spatial direction. The metric calculator is configured to calculate at least one metric based on the calculated parameter(s) for each the spatial direction. The beam former is configured to generate analog beams directed towards spatial direction(s) according to the calculated metric(s).

### FIELD

The present invention relates to a Remote Radio Head (RRH), a beamforming method and a storage medium storing a program, and more particularly to a RRH, a beamforming method and a program for beamforming and beam placement.

### BACKGROUND

Exploding growth in mobile broadband usage has created a variety of new applications and resulting in an exponential increase in amount of data exchange in both uplink and downlink. Recently, it is also observed that User Terminals (UTs) are not generally distributed uniformly in a radio coverage area of a Base Transceiver Station (BTS). This breaks a traditional view on a cell footprint that covers complete coverage area equally in all directions by one wide beam. It also prompts mobile network operators to realize an importance of optimizing coverage for both uplink and downlink such that it matches with user density distributions in both azimuth plane and elevation plane, effectively and adaptively. Therefore, for a current mobile communication system and future mobile communication system, optimizing a radio coverage area is one of the keys to improve spectral efficiency and system performance.

One possible approach based on deploying multiple antennas at both the BTS and the UTs, has already been adopted in standards such as Third Generation Partnership Project (3GPP) Long-Term Evolution (LTE) described in Non Patent Literature (NPL) 1. A multiple antenna system enables multi-input multi-output (MIMO) communication in both uplink and downlink; therefore, it increases spectral efficiency and improves system performance.

In addition to that, with large array active antenna MIMO architecture, coverage can be adaptively adjusted with respect to change of user density distributions by applying three-dimensional (3D) digital beamforming. However, such architecture requires a heavy signal processing and typically increases hardware and software complexity by ten-folds because of large number of Radio Frequency (RF) circuits in the BTS. Furthermore, such architecture also requires a precise coordination between digital beamforming and user scheduling (refer to Patent Literature (PTL) 1), and results significantly higher coordination overhead. In addition, such architecture may not be compatible with current high speed mobile communication standards and hardware specifications.

Recently, a new approach has been proposed in the literature for adaptive adjustment of the coverage to match user density distributions in both azimuth plane and elevation plane. This approach is based on integration of phased-array antennas to each RF circuit in a remote radio head (RRH) and then applying appropriate weightings to phase-shifting network for generating analog beam(s) in spatial directions with relatively higher user density distributions. Such architectures are termed as Hybrid Analog-Digital beamforming architecture in the wireless and mobile communication literature.

Hybrid Analog-Digital beamforming architecture applies two-level beamforming such as; a coarse-level analog beamforming with phased-array antennas in the RRH and a fine-level digital beamforming using baseband processing in a base band unit (BBU). Methods based on joint optimization of analog beamforming and digital beamforming using channel state information (CSI) from the BBU have been widely studied in the literature. However, such methods require tight integration between the BBU and the RRH functionalities, which may be not feasible with current BBU hardware.

To avoid such tight integration between the RRH and the BBU functionalities, analog beamforming in the RRH can be adjusted by using feedbacks from the UTs. However, it contradicts with current high speed mobile communication standards.

To overcome these problems, the RRH performs directional transmission/reception sweeping through all possible spatial directions and scanning a complete coverage area in order to estimate user density distribution. One such method is based on hierarchal search as described in NPL 2. Wherein, the RRH first transmits/receives signals using wider beams; iteratively beam-width is refined in potential spatial directions found in previous stage, and repeated until it covers maximum coverage. Hierarchal based search methods provide faster discovery of user density distributions in the coverage area.

However, a communication performance with hierarchal based search methods is relatively worse because of poor cell discovery, as a result of much less analog beamforming gain in initial stages due to wider beam-widths of analog beamforming. And further system is more likely to choose inaccurate beam(s) in a first stage because of high power side-lobes. In such cases, it will not be able to provide analog beamforming with acceptable Signal-to-Noise Ratio (SNR) in following stages.

To avoid this, method such as exhaustive search is generally adopted in the wireless and mobile communication literature, wherein the RRH transmits/receives by a narrow beam of equal beam-width in all the spatial direction. Exhaustive search achieves maximum coverage in all spatial direction and relatively simple to implement.

### CITATION LIST

### Patent Literature

[PTL 1]
U.S. Pat. No. 9,485,770B2
[PTL 2]
United States Patent Application Publication No. US2016/0021650A1

### Non Patent Literature

[NPL 1]
3GPP, “TS36.213 v11.8.0: E-UTRA physical layer procedures (Release 11),” 3GPP, September 2014
[NPL 2]
V. Desai, L. Krzymien, P. Sartori, W. Xiao, A. Soong and A. Alkhateeb, “Initial beamforming for mmWave communications” Signals, Systems and Computers, 2014 48th Asilomar Conference on, Pacific Grove, Calif., November 2014

### SUMMARY

According to the background, a method for adaptive adjustment coverage to match user density distributions in azimuth plane and/or elevation plane requires exhaustive scanning of complete coverage area by a narrow and directional analog beamforming. Wherein, the RRH transmits/receives in the narrow directional beams and sweeping through all possible spatial directions to estimate user density distribution in the coverage area. Such method requires a significant time to scan through all the spatial directions and further this scan duration is linearly increasing with a number of scan directions in the coverage area.

However, in realistic scenarios, users are generally distributed in some specific spatial regions for longer duration of a time, such as hotspots user distribution. Therefore, scanning all the spatial directions every time may not be necessary, as it results in significant degradation of a system performance due to relatively lower received/transmit powers during scanning less useful spatial directions for the communication and hence results in much lower effective communication durations in useful spatial directions.

One of an object of the present disclosure is providing a Remote Radio Head which contributes to improve a spectral efficiency and system performance.

According to a first aspect, there is provided a remote radio head with multiple antennas in a wireless communication system generating a plurality of analog beams to serve at least one user terminal, including: a parameter calculation unit (parameter calculator) configured to calculate at least one parameter including an un-scanned duration for each spatial direction; a metric calculation unit (metric calculator) configured to calculate at least one metric based on the calculated parameter(s) for each the spatial direction; and a beamforming unit (beam former) configured to generate analog beams directed towards spatial direction(s) according to the calculated metric(s).

According to a second aspect, there is provided a beamforming method performed in a remote radio head with multiple antennas in a wireless communication system generating a plurality of analog beams to serve at least one user terminal. The method includes: calculating at least one parameter including an un-scanned duration for each spatial direction; calculating at least one metric based on the calculated parameter(s) for each the spatial direction; and generating analog beams directed towards spatial direction(s) according to the calculated metric(s).

According to a third aspect, there is provided a storage medium storing a program executed by a computer embedded on a remote radio head with multiple antennas in a wireless communication system generating a plurality of analog beams to serve at least one user terminal. The program causes the computer to execute: calculating at least one parameter including an un-scanned duration for each spatial direction; calculating at least one metric based on the calculated parameter(s) for each the spatial direction; and generating analog beams directed towards spatial direction(s) according to the calculated metric(s).

The above-mentioned program can be recorded in a computer-readable storage medium. The storage medium may be a non-transient medium such as a semiconductor memory, a hard disk, a magnetic recording medium, or an optical recording medium. The present invention can be embodied as a computer program product.

According to the present disclosure, a Remote Radio Head (RRH) which contributes to improve the spectral efficiency and system performance is provided.

### BRIEF DESCRIPTION OF DRAWINGS

FIG. 1 illustrates an outline of an example embodiment.

FIG. 2 illustrates an example of a mobile communication system including a base transceiver station and a plurality of user terminals.

FIG. 3 illustrates an example diagram of a base transceiver station including a remote radio head and a base band unit.

FIG. 4 illustrates an example diagram of conventional remote radio head in a base transceiver station.

FIG. 5 illustrates an example diagram of sector-coverage using conventional remote radio head in mobile communication system.

FIG. 6 illustrates an example diagram of a remote radio head in a base transceiver station.

FIG. 7 illustrates an example block diagram of a remote radio head in Time Division Duplex system.

FIG. 8 illustrates an example block diagram of a remote radio head in Frequency Division Duplex system.

FIG. 9 illustrates an example block diagram of a frame in Time Division Duplex system.

FIG. 10 illustrates an example block diagram of a RF chain in a remote radio head.

FIG. 11 illustrates an example block diagram of a remote radio head in base transceiver station according to a first example embodiment.

FIG. 12 is a flowchart showing operations of the remote radio head according to the first example embodiment.

FIG. 13 illustrates an example block diagram of a remote radio head in base transceiver station according to a second example embodiment.

FIG. 14 is a flowchart showing operations of the remote radio head according to the second example embodiment.

FIG. 15 illustrates an example block diagram of a Remote Radio Head in base transceiver station according to one modification of the first example embodiment.

FIG. 16 illustrates an example block diagram of a Remote Radio Head in base transceiver station according to one modification of the second example embodiment.

FIG. 17 illustrates an example block diagram of a Remote Radio Head in base transceiver station according to another modification of the first example embodiment.

FIG. 18 illustrates an example block diagram of a Remote Radio Head in base transceiver station according to another modification of the second example embodiment.

FIG. 19 illustrates a block diagram showing a hardware configuration of a Remote Radio Head.

### DETAILED DESCRIPTION

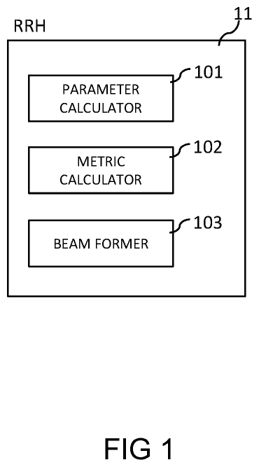

First, an outline of an example embodiment will be described with reference to FIG. 1. In the following outline, various components are denoted by reference characters for the sake of convenience. Namely, the following reference characters are merely used as examples to facilitate understanding of the present invention. Thus, the present disclosure is not limited to the description of the following outline. In addition, connecting lines between blocks in each figure include both bidirectional and unidirectional. One-way arrow schematically shows a flow of a main signal (data), and does not exclude bidirectionality. In addition, in this document, “and/or” represents at least one of preceding and following elements of this expression. For example, “item 1 and/or item 2” indicates “at least one of item 1 and item 2”.

A Remote Radio Head (RRH) 11 has multiple antennas in a wireless communication system generating a plurality of analog beams to serve at least one user terminal. The RRH 11 includes a parameter calculator 101, a metric calculator 102 and a beam former 103. The parameter calculator 101 is configured to calculate at least one parameter including an un-scanned duration for each spatial direction. The metric calculator 102 is configured to calculate at least one metric based on the calculated parameter(s) for each the spatial direction. The beam former 103 is configured to generate analog beams directed towards spatial direction(s) according to the calculated metric(s). It should be noted that the RF chain is a circuit module in which circuits for modulation or demodulation of analog and digital signals are connected in cascade.

The RRH 11 can improve a spectral efficiency and system performance significantly. This is because of improving effective communication duration by avoiding the scanning of less useful spatial directions for a communication for relatively longer durations of a time and then adaptively prioritizing these spatial directions, if the un-scanned durations become comparatively larger. This is to avoid miss-detection of new emerging users. In addition, the RRH 11 is fully compatible with current high speed mobile communication standards and hardware functionalities. That is, in the mobile communication system including the RRH 11 employing multiple antennas and at least one user terminal and that can perform communication between each other, the RRH 11 adaptively aligns analog beamforming to match user density distribution in order to maximize the communication duration and to improve Quality of Service and system throughput.

### Example Embodiment

The present disclosure and its advantages can further be understood with a help of following description. In the following, example embodiments of the present disclosure are described with reference to the drawings. For illustrating the present disclosure, example embodiments are constructed by assuming its application to the mobile communication system. Note that, reason for assuming the mobile communication system is only to simplify the illustration. In fact, the present disclosure can be applied to any wireless communication system that uses directional transmission/reception by a skilled person in the art.

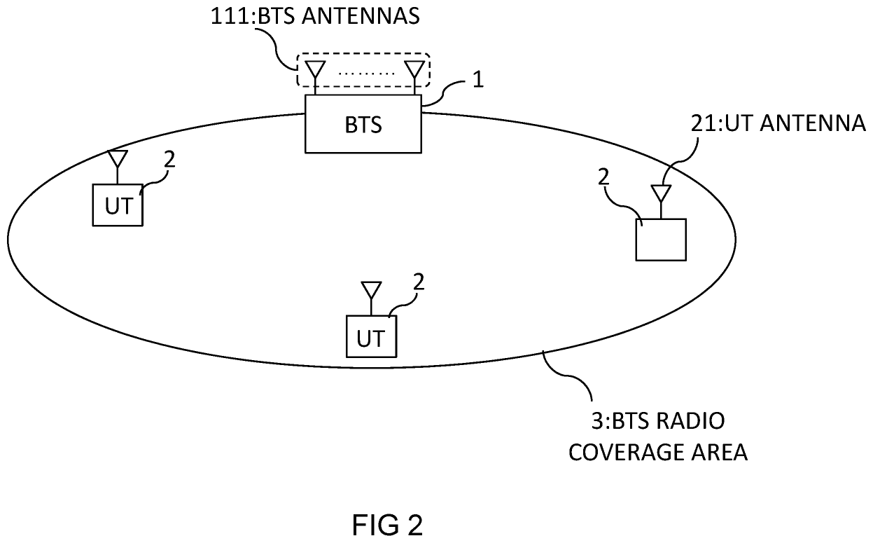

First, a mobile communication system and a user terminal, which are used in common for describing the present disclosure, are explained in details by making reference to FIG. 2 to FIG. 10.

FIG. 2 shows an example diagram of a mobile communication system that includes a Base Transceiver Station (BTS) 1 and User Terminals (UTs) 2. Note that, usage of the UTs 2 with a signal UT antenna 21 is only for illustrative purpose, and the present disclosure can be applied to a system with any number of antennas at the UTs 2 by a skilled person in the art. All the UTs 2 are located in a BTS radio coverage area 3 and can communicate with the BTS 1 in both uplink and downlink directions.

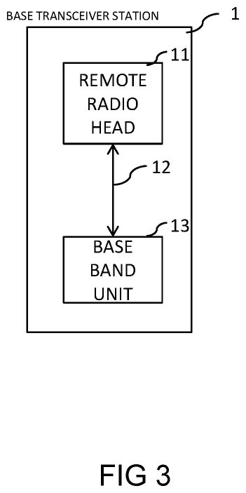

FIG. 3 shows an example diagram of the BTS 1. Referring to FIG. 3, the BTS 1 includes a Remote Radio Head (RRH) 11 and a Base Band Unit (BBU) 13. The RRH 11 and the BBU 13 can be deployed at a same location or on different locations, and both are connected with each other by a bidirectional radio interface bus 12 as shown in FIG. 3.

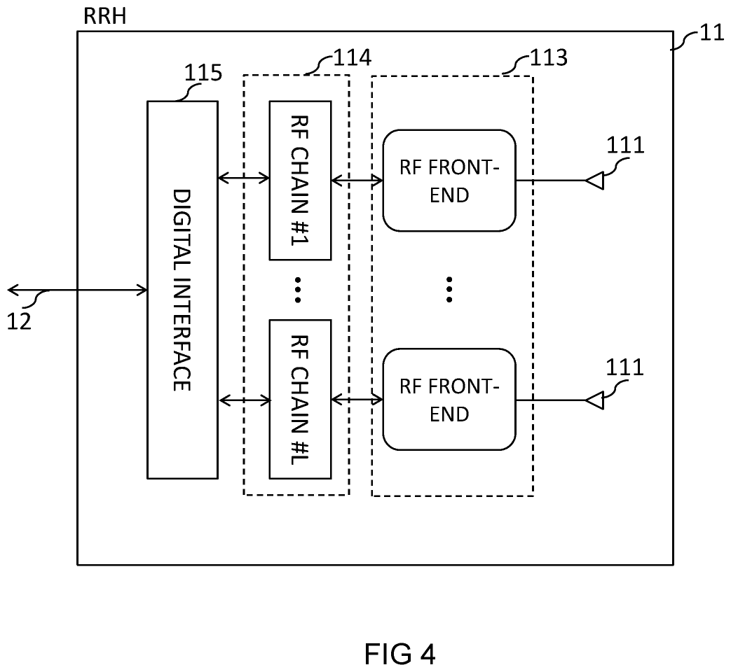

FIG. 4 illustrates an example diagram of a conventional RRH 11 which does not support analog beamforming, the RRH 11 mainly realizes Radio Frequency (RF) functionalities of the BTS 1. Referring to FIG. 4, the RRH 11 includes antennas 111, RF front-ends 113, RF chains 114 and a digital interface 115. L RF chains 114 and L RF front-ends 113 are included in the RRH 11 (L is a number of RF chains and RF front-ends existing in the RRH 11).

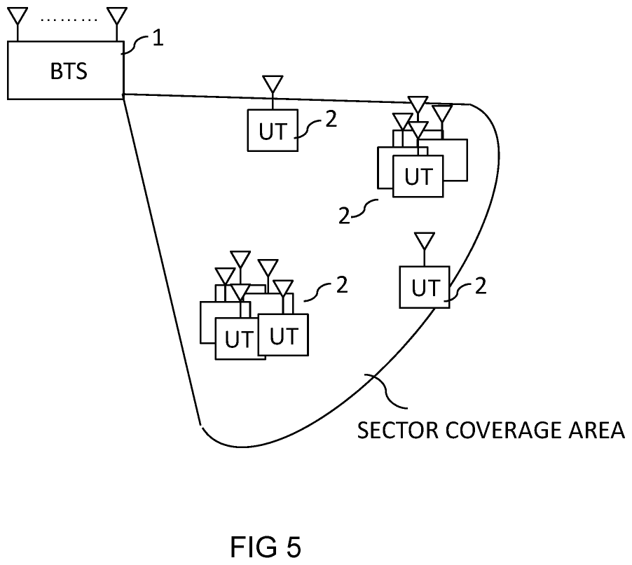

The RRH 11 described in FIG. 4 performs Omni-directional or sectored transmission/reception by one wide beam that covers a cell-specific cell footprint in both azimuth and elevation plane. More specifically, transmission of the downlinks signals from the BTS 1 to different UTs 2 and reception of uplink signals from the different UTs 2 to the BTS 1 are performed by using one wide beam that cover complete sector region or cell coverage equally in all directions, in other words, without applying user-specific and/or cell-specific beamforming, as shown in FIG. 5.

However, a spectral efficiency and system performance can be improved by applying user-specific and/or cell-specific beamforming to match user density distribution and/or traffic demand in the cell coverage area.

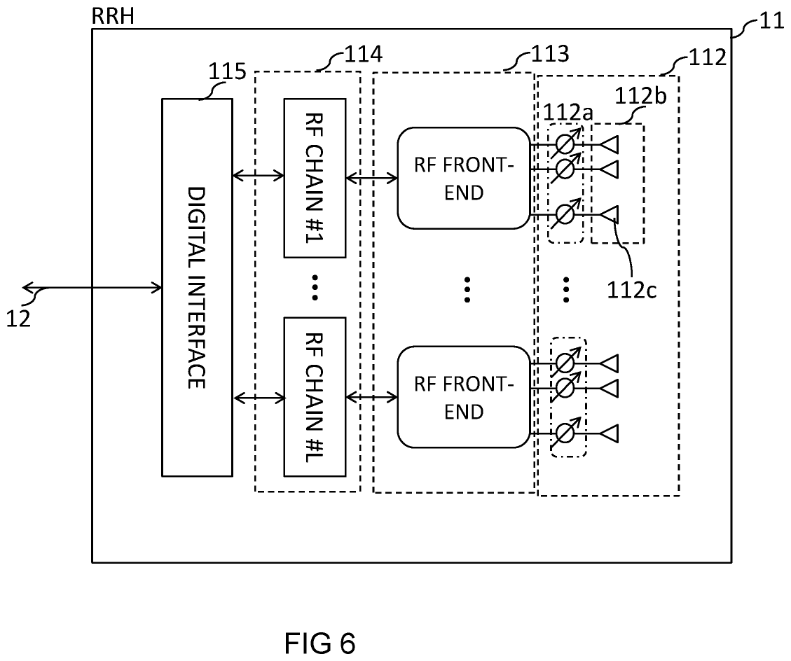

FIG. 6 shows an example diagram of the RRH 11 which supports beamforming. Comparing FIG. 4 with FIG. 6, phased-array antennas 112 are connected to the RF front-end 113 in place of the antennas 111. In addition, each sub-array 112b including a plurality of antenna elements 112c is connected to each RF front-end 113.

For an adaptive adjustment of the coverage to match user density distributions in azimuth and elevation plane, the phased-array antennas 112 are integrated to each RF circuit in the RRH 11. All the phased-array antennas 112 can be used for both transmission and reception of signals to and from the UTs 2, respectively. The transmission of uplink signals to the UTs 2 and reception of downlink signals from the UTs 2 can be multiplex in time or frequency, which is controlled by the RF front-end 113.

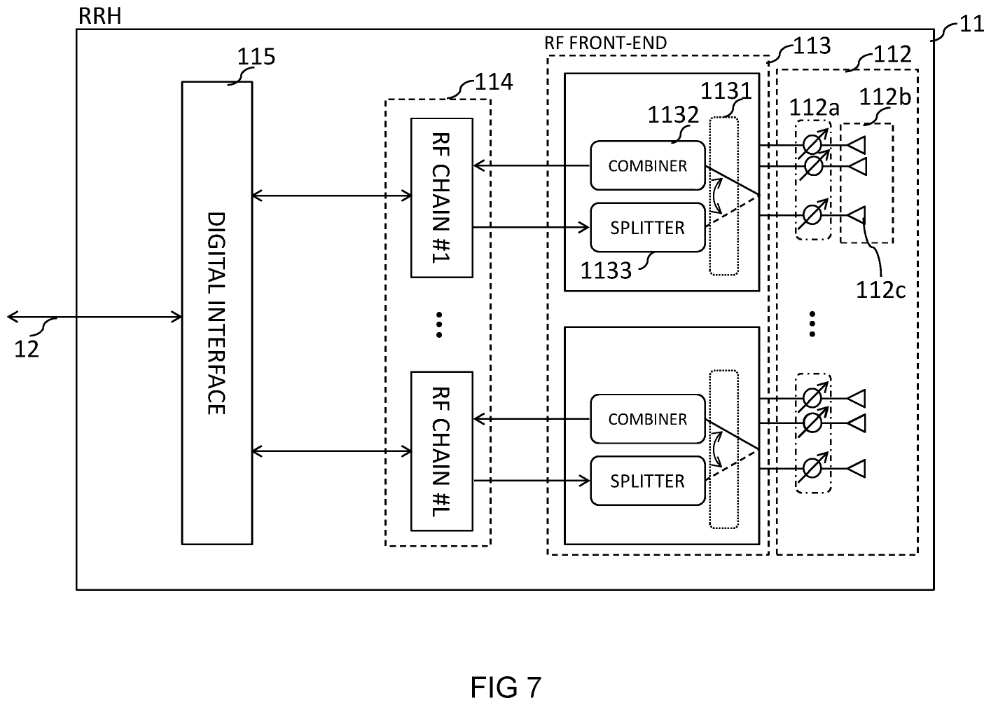

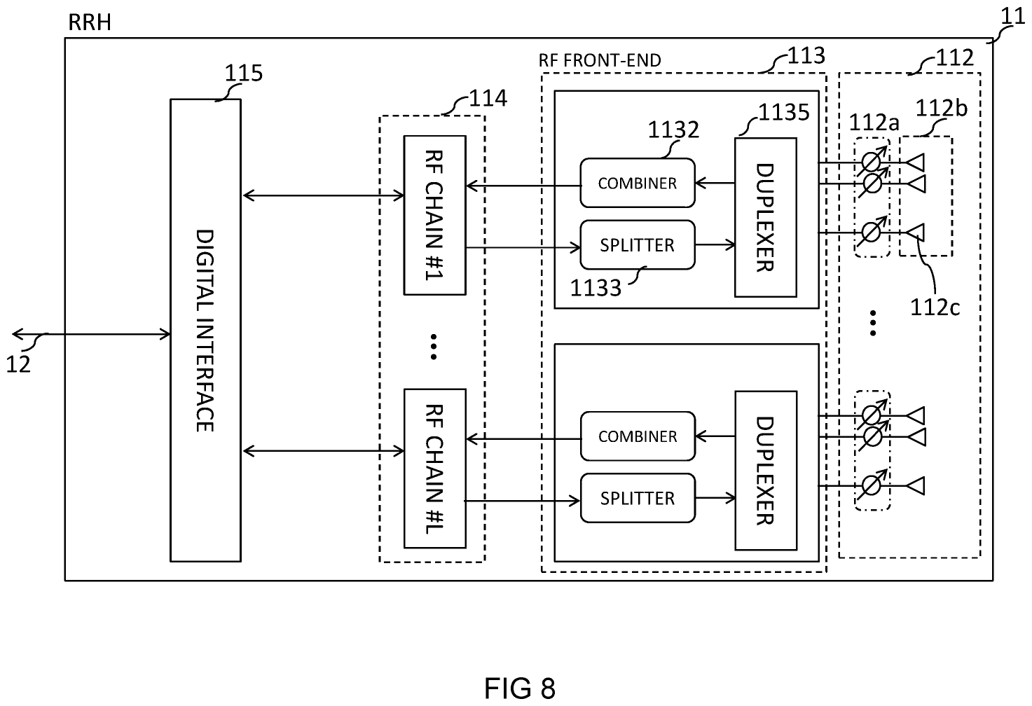

FIGS. 7 and 8 illustrate an example block diagram for Time Division Duplex (TDD) system and Frequency Division Duplex (FDD) system, respectively. For example, in a case of TDD system, same antenna can be used for both reception of uplink signals and transmission of downlink signals, where the reception and transmission in the RRH 11 is controlled by a receive/transmit switch 1131, as shown in FIG. 7.

In a case of FDD system, all the antennas can be used for both transmission of downlink signals to the UTs 2 and reception of uplink signals from the UTs 2. FIG. 8 illustrates the example diagram of the RRH 11 in FDD system in which transmission of downlink signals and reception of uplink signals are performed on separate frequencies at the same time, where a duplexer 1135 separates receive frequency components from transmit frequency components. Note that, a detailed block diagram and operation of RF front-end 113 for both TDD system and FDD system are well known to a skilled person in the art. Therefore, detailed explanation of the RF front-end 113 is omitted in the present disclosure.

It should be noted here that, total number (N) of the phase-array antennas 112 are comparatively much higher than a number (L) of the RF chains 114 i.e., N>>L. A connection between the phased-array antennas 112 and the RF chains 114 can be realized in several ways. One of a possible approach is when all the phased-array antennas 112 connect to each RF chain 114, such that the transmitted and/or received signals goes through all the RF paths, such architectures are called full-array architectures in wireless and mobile communication literature.

Another possible approach is splitting total antennas into sub-array of equal size or different sizes and each sub-array connects to the separate RF chain 114, such architectures are known as sub-array architectures in wireless and mobile communication literature.

There can be several other approaches to connect the phased-array antennas 112 with the RF chains 114, however, the present disclosure can easily be applied, irrespective of the approach or method for connecting the phased-array antennas 112 with the RF chains 114, by a skilled person in the art.

Each antenna element 112c in the sub-array 112b is connected to a separate analog phase-shifter 112a. For illustration purpose, here we consider linear sub-array, however, the present disclosure is valid for other antenna array configurations such as rectangular, square and/or circular. The uplink received signals from the individual antenna element 112c is phase-shifted and then combined by a combiner 1132 to provide an output of sub-array 112b, which is called uplink analog beamforming. Similarly, for downlink analog beamforming, transmitted signals in downlink are first split by a splitter 1133 and then phase-shifted for each antenna element 112c in the sub-array 112b.

The RRH 11 can generate one or more, wider beams and/or narrower beams and can steer beams to any spatial direction by applying corresponding beamforming weights including both phase-shifts and amplitude to each antenna element 112c in each sub-array 112b. It should be noted here, the use of the phase-shifter 112a is only for illustrative purpose, and the present disclosure can be applied to a system with butler matrix or any other similar phase-shifting network 112a, that can be used for generating analog beamforming in both uplink and downlink, by a person skilled in the art.

It should be noted here, a maximum number of simultaneous analog beams of the RRH 11 are always upper bounded by the number of RF chains 114. In other words, at maximum only L different spatial directions can be selected out of B, for analog beamforming. L is the total number of the RF chains 114 and B is the maximum number of spatial directions, where B>=L.

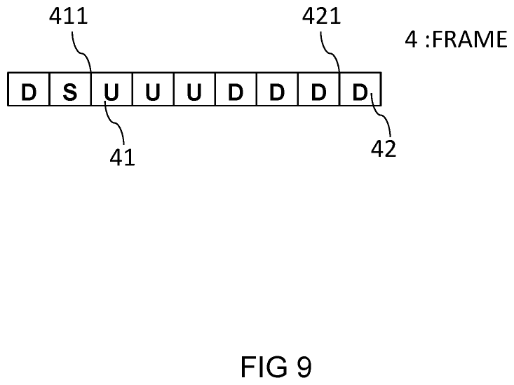

Further in the case of TDD system, all the L analog beams can be used for both uplink data reception and downlink data transmission, but in different time slots. FIG. 9 is an example of a frame in TDD system. Referring to FIG. 9, where a number of uplink time slot 41 and downlink time slot 42 in a frame 4 can be decided and adjusted adaptively based on system requirements. Such that, for maximization of uplink performance, more time slots will be dedicated to uplink data reception and vice versa for downlink data transmission, in TDD system. Similarly for FDD system, uplink and downlink frequency bandwidth can be decided and adjusted adaptively based on system requirements. It should be noted that in FIG. 9, reference numerals 411 and 421 represent a start of uplink time slot and a start of downlink time slot, respectively.

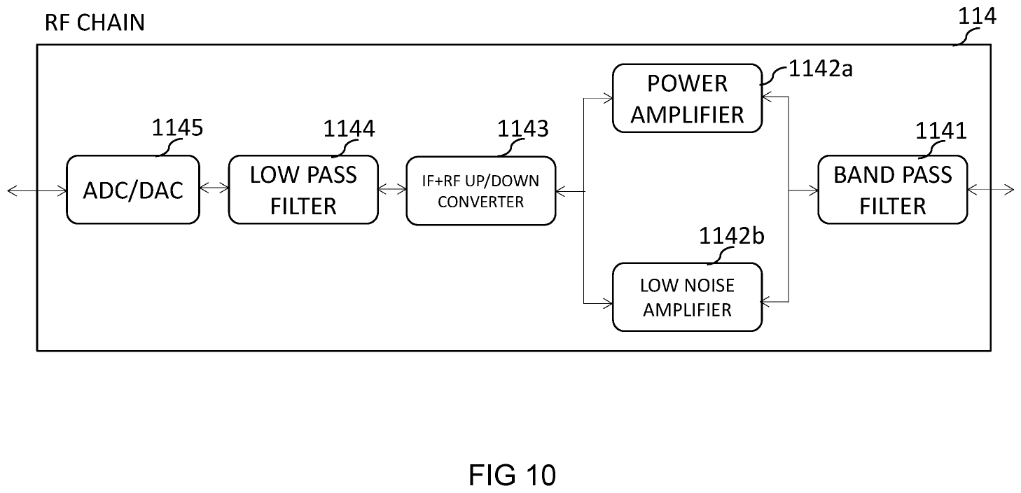

FIG. 10 shows an example block diagram of the RF chain 114 included in the RRH 11. Referring to FIG. 10, the RF chain 114 includes a band pass filter 1141, a power amplifier 1142a, a low noise amplifier 1142b, an IF+RF up/down converter 1143, a low pass filter 1144 and an Analog-to-Digital converter (ADC)/Digital-to-Analog converter (DAC) 1145. When data is transmitted to the UTs 2, the RF chain 114 modulates a baseband signal to a radio frequency band. When data is received from the UTs 2, the RF chain 114 demodulates the signal in the radio frequency band to the baseband signal.

Referring to FIG. 3 and the like, the digital interface 115 exchanges data with the BBU 13 via the bidirectional radio interface bus 12.

The RRH 11 defines an optimization function to find candidate or potential spatial direction(s) for analog beamforming in both uplink and downlink, in order to avoid exhaustive scanning all the spatial directions for each time intervals, such that, system achieves a better balance between communication with the existing UTs 2 in useful directions and miss-detection of new emerging users in other spatial directions. The RRH 11 then steers the analog beamforming towards the useful spatial directions in both azimuth plane and elevation plane by applying appropriate weighting to the phase-shifters 112a. More details about an operation will be given when a specific example embodiment of the present disclosure are described.

It should be noted here, the present disclosure provides the RRH 11 and a method for the RRH 11 communicating with any general BBU 13 and the UTs 2. The detailed block diagram and operations of the BBU 13 and the UTs 2 are well known to a skilled person in the art and therefore omitted in this document.

In the following, based on the above-mentioned explanation of common system and devices, details specific to each example embodiment of the present disclosure will be described in respective order.

### First Example Embodiment

A first example embodiment will be described more in detail below with reference to the drawings.

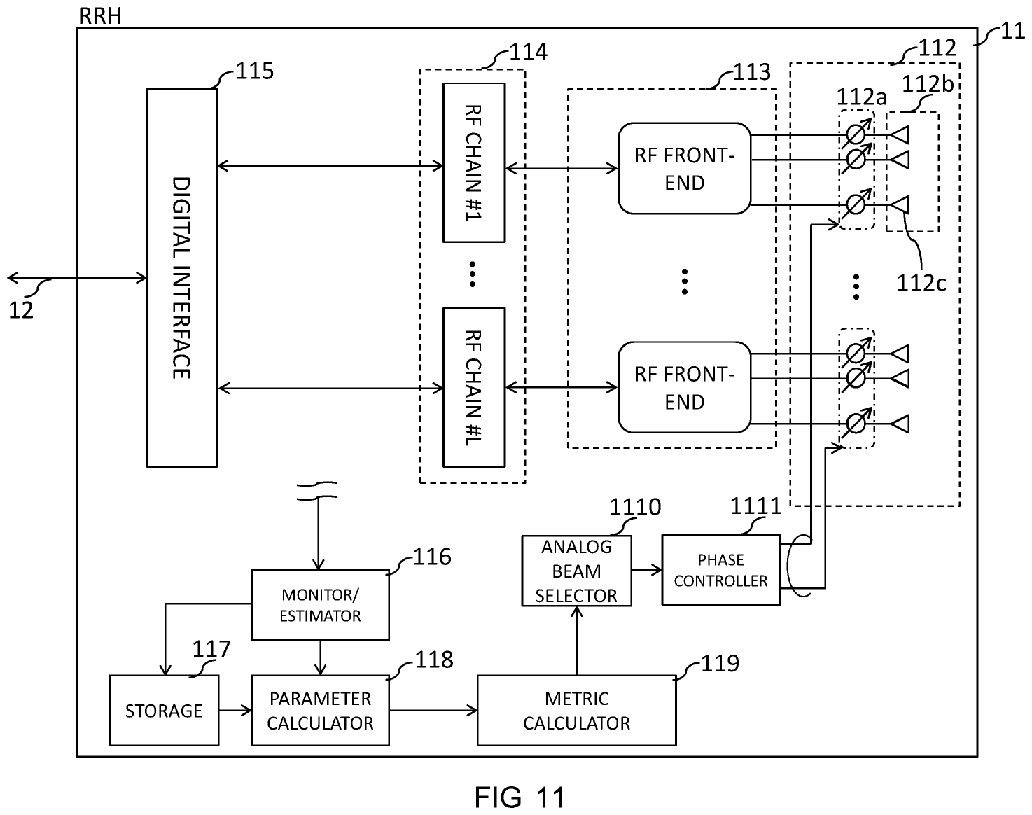

FIG. 11 shows an example block diagram of RRH 11 according to the first example embodiment. Referring to FIG. 11, the RRH 11 further includes a combined monitor/estimator (combination) 116, a storage 117, a parameter calculator 118, a metric calculator 119, an analog beam selector 1110 and a phase controller 1111. The parameter calculator 118 corresponds to the above-mentioned parameter calculator 101. The metric calculator 119 corresponds to the above-mentioned metric calculator 102. The analog beam selector 1110 and the phase controller 1111 correspond to the above-mentioned beam former 103.

The first example embodiment provides a method in the mobile communication system including the RRH 11 equipped with the phased-array antennas 112, performing directional transmission and reception with plurality of the UTs 2 in downlink and uplink, respectively.

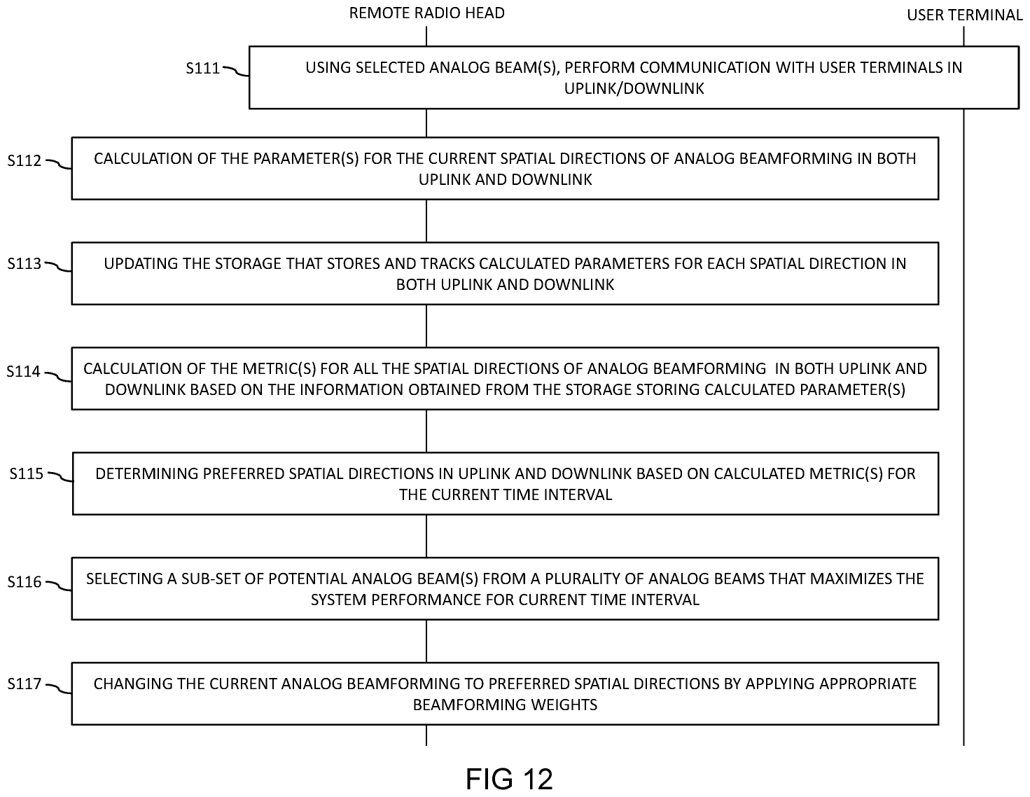

The RRH 11 according to the first example embodiment calculates at least one parameter for each spatial direction that represents un-scanned duration and/or power level. The RRH 11 then calculates at least one metric in order to optimize a communication duration in the spatial directions with relatively higher user density distribution and also avoiding miss-detection of new emerging users in other spatial directions, such that, system achieves a better balance for each time interval. Finally, the RRH 11 steers the analog beamforming in the potential spatial directions of the calculated metric by applying appropriate weightings to the phase-shifters 112a. In the following, details of the first example embodiment are described by making reference to FIG. 11 and FIG. 12.

### <System Operation>

FIG. 12 shows an operation of overall system including both the RRH 11 and the UTs 2. At the beginning, the RRH 11 selects sub-set of analog beams from a plurality of analog beams defined by a RRH designer and/or supported in the equipment. It should be noted, the RRH 11 can generate one or more analog beams with same or different beam-width in both azimuth and elevation plane, where one or more beams can be aligned in specific spatial direction. Here, it is assumed that the RRH 11 has already selected some potential spatial directions for analog beamforming based on some optimization function by using previous knowledge on user density distribution and/or un-scanned durations and/or other similar parameters, for each spatial direction in the coverage area. Therefore, a first operation S111 shows the RRH 11 communicating with the potential UTs 2 in both uplink and downlink on the specified spatial direction(s) using analog beamforming that maximizes the calculated metric.

The combined monitor/estimator 116 monitors signals of the analog beamforming for current spatial direction(s), continuously or on predefined intervals. Based on this information and also using a previous history for all other spatial directions from the storage 117, the parameter calculator 118 calculates at least one parameter representing characteristics for all the spatial directions of analog beamforming in both uplink and downlink (operation S112).

For example, one such parameter can be obtained by calculating the un-scanned duration for all the spatial directions and/or by estimating the power levels in both uplink and downlink for each spatial direction and/or any other similar parameter or combination of these parameters representing the characteristics for each spatial direction for each time interval.

After calculating the parameter(s), the parameter calculator 118 updates the storage 117. The storage 117, which stores and tracks the calculated parameters for each spatial direction in both uplink and downlink, is updated (operation S113).

After the calculation of the at least one parameter for all the spatial directions, the metric calculator 119 calculates at least one metric such that it maximizes the communication duration by analog beamforming in useful spatial directions where users are densely distributed and simultaneously it minimizes miss-detection of new users in other spatial directions (operation S114).

For example, one such metric can be obtained considering optimization function with at least two parameters representing un-scanned duration and power levels for each spatial direction in the coverage area.

The parameter calculator 118 then categorizes spatial directions for analog beamforming. For example, spatial directions can be categorized by sorting all spatial directions with respect to decreasing order of the calculated metric (operation S115).

The analog beam selector 1110 then selects a sub-set of potential spatial direction(s), such that the calculated metric is relatively higher (operation S116). The RRH 11 performs analog beamforming in those specified direction(s).

Finally, the phase controller 1111 steers the analog beams by applying appropriate beamforming weights including both phase-shifts and amplitude to each phase-shifter in phased-array antennas 112b (operation S117). The RRH 11 steers the analog beamforming in the potential spatial directions. An assignment of phase-shifting weights to each sub-array for generating analog beamforming in subsequent time interval depends on assigned phase-shifting weights in previous time interval, in other words user distribution, such that, change of analog beamforming at each sub-array should not results in higher SNR variations at the BBU 13. This is because the analog beamforming is applied relatively for long-term and in coarse-level, which is common for all the sub-carriers used for data communication.

Based on the above-mentioned explanation of the first example embodiment, it can be concluded that a spectral efficiency and system performance are improved by optimizing the cell coverage with adaptive analog beamforming in both azimuth plane and elevation plane with respect to change user density distribution for each time interval. The present disclosure achieves comparatively better communication durations due to avoiding scanning of less useful spatial directions for the communication for relatively longer duration of time. Furthermore, the present disclosure also achieves a better balance between data communication and miss-detection by adaptively prioritizing each spatial direction, if the un-scanned duration becomes comparatively larger.

To provide a better understanding on the operations of the first example embodiment, we provide one example case.

According to the operations of first example embodiment, the RRH 11 first calculates at least one parameter representing the characteristics in each spatial direction (operation S112). Let, the maximum number of spatial directions B be total spatial directions in the coverage area. Since, the RRH 11 can generate at most L analog beams, where B>=L. Therefore, one such parameter that represents characteristics of each spatial directional can be obtained by calculating the un-scanned duration Δt, for each spatial direction b, i.e., Δt_{b}∀b=1, 2, . . . , B, where ∀ is a universal quantifier indicating “given any” or “for all”. ∀ b=1, 2, . . . , B indicates that the b takes any value out of 1, 2, . . . , B.

In addition, based on the calculated power levels P_{b} for each spatial direction, we can estimate the user density distribution. Therefore, P_{b} is also one of the key parameters that represent characteristics of each spatial direction in the coverage area.

Another parameter representing characteristic of each spatial direction can be obtained by comparison of power levels with pre-defined thresholds. Such as, spatial direction(s) satisfying thresholds represents relatively higher user density distributions compared to other spatial directions with power levels below pre-defined threshold values.

Another parameter representing the characteristics of each spatial direction can be obtained by measuring a duration in which the calculated powers are above the pre-defined threshold for each spatial direction of analog beamforming. Such as, spatial direction(s) satisfying a threshold for longer duration represent higher user density distributions compared to other spatial directions.

Similarly, there exist several other identical parameters and/or combination of parameters representing the characteristics for each spatial direction b. However, to simplify an explanation, we will consider only two parameters for this example case, i.e., absolute value of calculated power P_{b} and un-scanned duration Δt_{b} for each spatial direction. In fact, consequences of considering several parameters and/or combination of parameters are straight forward and well known to a skilled person in the art.

The RRH 11 then calculates at least one metric based on the calculated parameters (operation S114) such that it improves the system performance by maximizing the communication duration and minimizing the miss-detection of new user. This is because, at any particular time interval, analog beamforming can communicate in at most L different spatial directions out of B, where B>=L. Therefore, objective of the optimization function is to find sub-set of potential spatial directions for analog beamforming such that it optimize the communication duration in the directions with relatively higher user density distribution while avoiding the miss-detection of new emerging user in other spatial directions. One such metric can be obtained with a help of following optimization function;

[symbol]

_{b}(t)=ƒ(Δt_{b},P_{b})∀b=1,2, . . . ,B [Math. 1]

Where, M_{b} (t) represents the calculated metric for spatial direction b at time t. The un-scanned duration and power levels in spatial direction b are given by Δt_{b} and P_{b}, respectively. After calculating the metric M_{b} (t) for all the spatial directions such as [symbol] _{b}(t) ∀ b=1, 2, . . . , B, the RRH can choose at most L potential spatial directions for analog beamforming (operation S115).

One possible method can be, sorting all the spatial directions in descending order based on the calculated values of metric and then selecting first L spatial directions out of B. Finally, the RRH 11 steers the analog beamforming in all the potential spatial directions by applying appropriate beamforming weights (operations S116 and S117).

To avoid higher SNR variations at the BBU 13, beamforming weight to each sub-array are assigned in such a way that it occupies nearest potential spatial direction for analog beamforming in subsequent time interval. To achieve a better balance between data communication duration and miss-detection of new users, the corresponding optimization function may have following relationship with the calculated parameters;

$$f ( Δ {t}_{b} , {P}_{b} ) ∝ {P}_{b} ; \frac{1}{Δ {t}_{b}} \qquad [ Math . 2 ]$$

One such optimization function can be obtained by simple multiplication of both parameters, such as

$$f ( Δ {t}_{b} , {P}_{b} ) = {P}_{b} \frac{1}{Δ {t}_{b}} .$$

We can also derive similar optimization function by using probabilistic approach, i.e.,

$$f ( Δ {t}_{b} , {P}_{b} ) = ( w ) {P}_{b} + ( 1 - w ) \frac{1}{Δ {t}_{b}} .$$

Where w is a weighting coefficient i.e., 0<=w<=1. A value of w can be decided and adjusted adaptively based on system requirements. For maximization of system throughput (w need to be greater than 0.5; w>0.5), effective communication durations are maximized by aligning the analog beamforming in the direction of higher user density distributions for relatively longer durations. Similarly, to avoid miss-detection of new emerging user, scanning other spatial directions is performed more frequently (w need to be 0.5 or less; w<=0.5).

In the same way, there may exist several other optimization functions derived from one or more similar parameters and/or combination of parameters. However, their effect is well known to a skilled person in the art.

### Second Example Embodiment

A Second example embodiment will be described more in detail below with reference to the drawings.

In summary, the second example embodiment makes one modification to the first example embodiment. In particular, the second example embodiment introduces a new method for determining and selecting preferred spatial directions of analog beamforming for both uplink and downlink. For example, the RRH 11 calculates an average metric for each spatial direction and then selecting at least one potential spatial direction that maximizes the average metric. The operation of calculating average metric and selecting at least one potential spatial direction that maximizes the average metric is repeated until at least L potential spatial directions are decided.

Based on such addition to the first example embodiment, the second example embodiment modifies functionalities of hardware components used for calculating the metric for each spatial direction of analog beamforming.

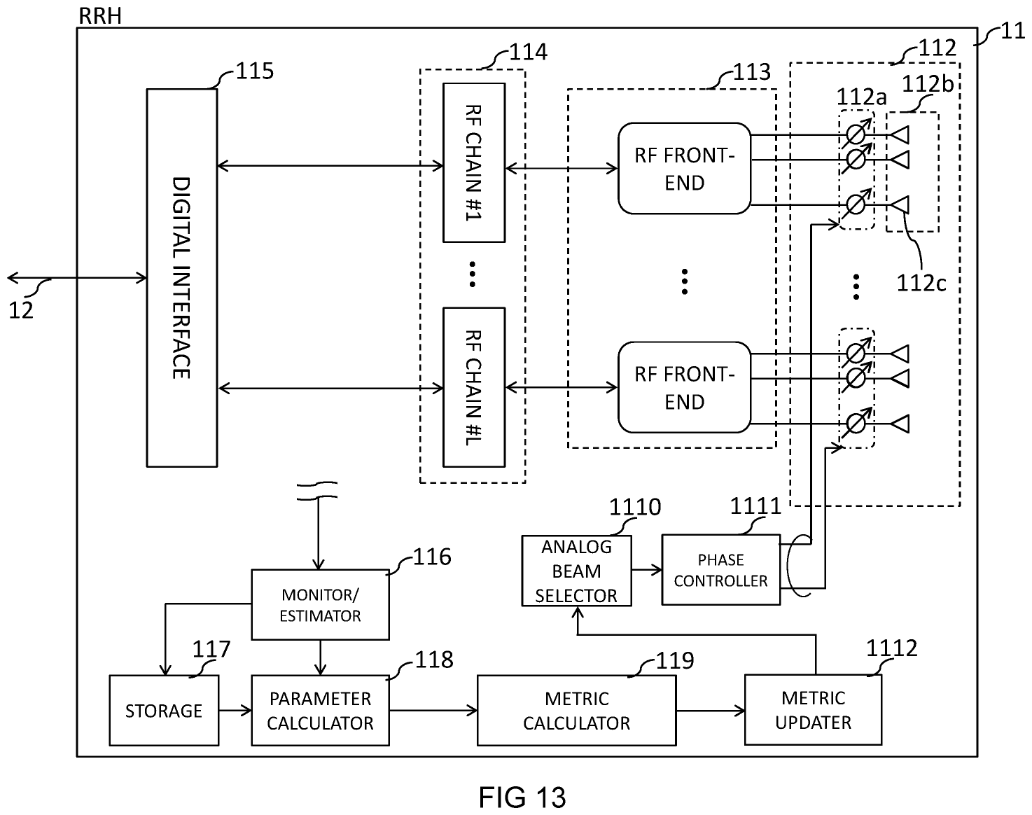

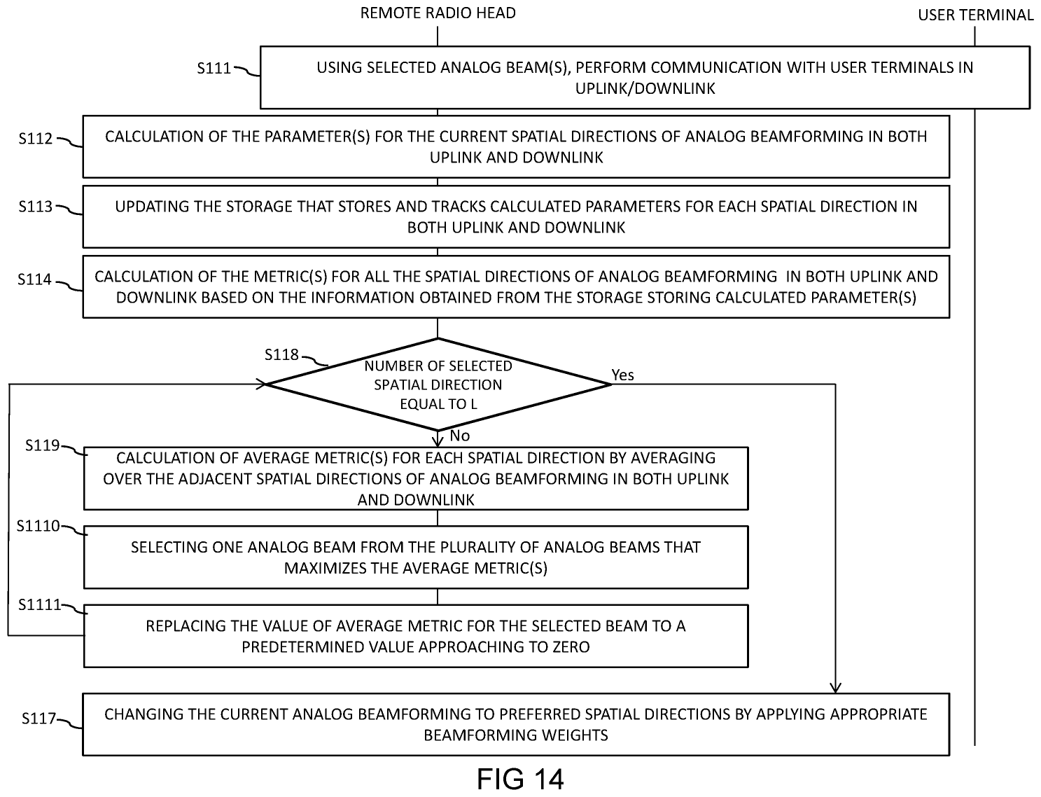

In the following, details of the second example embodiment are described by making reference to FIG. 13 and FIG. 14.

Referring to FIG. 13, a metric updater 1112 is added to the RRH 11 of the first example embodiment shown in FIG. 11. The metric updater 1112 calculates the average metric for each spatial direction by averaging the calculated metric over the adjacent spatial directions of analog beamforming for both uplink and downlink.

### <System Operation>

FIG. 14 shows an operation of overall system including both the RRH 11 and the UTs 2. The first four operations S111 to S114 are similar to the operations of first example embodiment. The RRH 11 selects a sub-set of potential spatial directions for analog beamforming and communicates with the UTs 2 in both uplink and downlink (operation S111). Then, the parameter calculator 118 calculates at least one parameter representing the characteristics of each spatial direction of analog beamforming in both uplink and downlink (operation S112). Then, and the parameter calculator 118 updates the storage 117 (operation S113). Then, the metric calculator 119 calculates at least one metric for each spatial direction of analog beamforming using the calculated parameters (operation S114).

At first, the metric updater 1112 determines whether a number of selected spatial direction equal to L or not (operation S118). If the number of selected spatial direction equal to L, a process proceeds to operation S117. If the number of selected spatial direction does not equal to L, a process proceeds to operation S119.

The metric updater 1112 calculates the average metric for each spatial direction by averaging the calculated metrics over the adjacent spatial directions of analog beamforming for both uplink and downlink (operation S119). For example, one such average metric can be obtained by considering only immediate adjacent spatial directions and computing the average metric by using the values of the calculated metrics of adjacent spatial directions.

The metric updater 1112 then selects only one spatial direction with a highest value of the calculated average metric and stores it in the storage 117 (operation S1110).

The calculated value of the average metric for the selected spatial direction is replaced with a different value before averaging for the next iteration (operation S1111). For example, one such value for the replacement can be obtained by subtracting the (1/L) of the total metric in the analog beam corresponding to the selected spatial direction.

Additionally, a fraction of the power in the adjacent analog beams used for the calculation of the average metric of the selected spatial direction can also be subtracted (removed) to avoid selection of the spatial directions that are very close to the already selected spatial directions. Such operation of the metric updater 1112 corresponds to updating the metric by subtracting a portion of the calculated metric of the adjacent spatial directions to the selected spatial direction(s). That is, the metric updater 1112 updates the metric by the portion of the calculated metric of the selected spatial direction(s).

Another possible method can be, replacing the average metric of the selected spatial direction with a predetermined value (for example, very small value) to avoid reselection of the already selected spatial directions in the successive iterations. Similarly, there exists several other identical methods for replacing the value of average metric of selected spatial directions. In fact, consequences of considering other methods and/or combination of methods are straight forward and obvious to a person skilled in the related art. For example, the metric updater 1112 may update the metric by subtracting the portion of the calculated metric considering number of RF chains 114 in the system, number of antennas 112 in the system, number of analog beams in the system, or user distribution in the system.

The metric updater 1112 repeats the operation of calculating the average metric by considering modified value of the selected spatial direction(s) and selecting at least one potential spatial direction that maximizes the average metric, until at least L potential spatial direction are decided. Where, L is the maximum number of simultaneous analog beams supported in the RRH 11.

Finally, the RRH 11 steers the analog beams by applying appropriate beamforming weights to each phase-shifter in phased-array antenna 112b (operation S117) and steers the analog beams in the potential spatial directions. It should be noted, the assignment of phase-shifting weights to each sub-array for generating analog beamforming in subsequent time interval depends on the assigned phase-shifting weights in previous time interval, in other words user distribution, such that, the change of analog beamforming at each sub-array should not results in higher SNR variations at the BBU 13.

Based on the above-mentioned explanation of the second example embodiment, it can be concluded that the second example embodiment further improves the first example embodiment. Specifically, selection of the analog beams based on the average metric calculated using adjacent spatial directions will align the analog beams to the regions with relatively higher user density distributions in the coverage area.

To provide a better understanding on the operation of determining and selecting preferred spatial directions of analog beamforming for the second example embodiment, we provide one example case.

The detailed explanations of operation S111 to S114 have been covered in Example of the first example embodiment, therefore it is omitted here for conciseness.

Let, m_{b}(t) be the calculated metric for the spatial direction b at time t. Such that, [symbol] (t)={m₁(t), m₂(t), . . . , m_{B}(t)} represents the calculated metric for all the spatial directions of analog beamforming. At first, initialization of a metric [symbol] (t)= [symbol] (t) for the first iteration is executed. The RRH 11 then calculates the average metric m̅_{b}(t) for each spatial direction b, ∀b=1, 2, . . . , B (operation S119). One such average metric can be obtained based on calculated metric of adjacent spatial directions. By using the mathematical notation in the related arts of the mobile communication system, the calculated average metric can be expressed by following mathematical notations;

$${\overline{m}}_{b} ( t ) = \frac{1}{2 A + 1} {\sum }_{j = b - A}^{b + A} {\hat{m}}_{j} ( t ) ∀ b = 1 , 2 , … , B \qquad [ Math .3 ]$$

Where, A is a positive number, it represents the number of adjacent spatial directions used for calculation of the average metric for each spatial direction. Based on this calculated average metric set [symbol] (t), the RRH 11 then selects one spatial direction corresponding to the highest value of the average metric set [symbol] (t) and store it (operation S1110).

The RRH 11 updates the metric set [symbol] (t) based on the current selection of analog beam. One such update can be realized by replacing the calculated metric corresponding to the selected analog beam with a very small value (operation S1111). For example, m̅ₕ(t) be the highest of the average metric set [symbol] (t). The RRH 11 stores the index h in the storage 117 and defines a new metric [symbol] (t), such that, [symbol] (t)={\hat{m}₁(t), \hat{m}₂(t), . . . , \hat{m}ₕ₋₁(t), ε, \hat{m}ₕ₊₁(t), . . . , \hat{m}_{B}(t)}, where ε≈0.

The calculation of average metric using current average metric (operation S119), selection of one spatial direction (operation S1110) and updating the average metric accordingly (operation S1111), are repeated until at least L spatial directions have been decided for current time interval. Finally, the RRH 11 steers the analog beamforming in all the potential spatial directions by applying appropriate beamforming weights (operation S117).

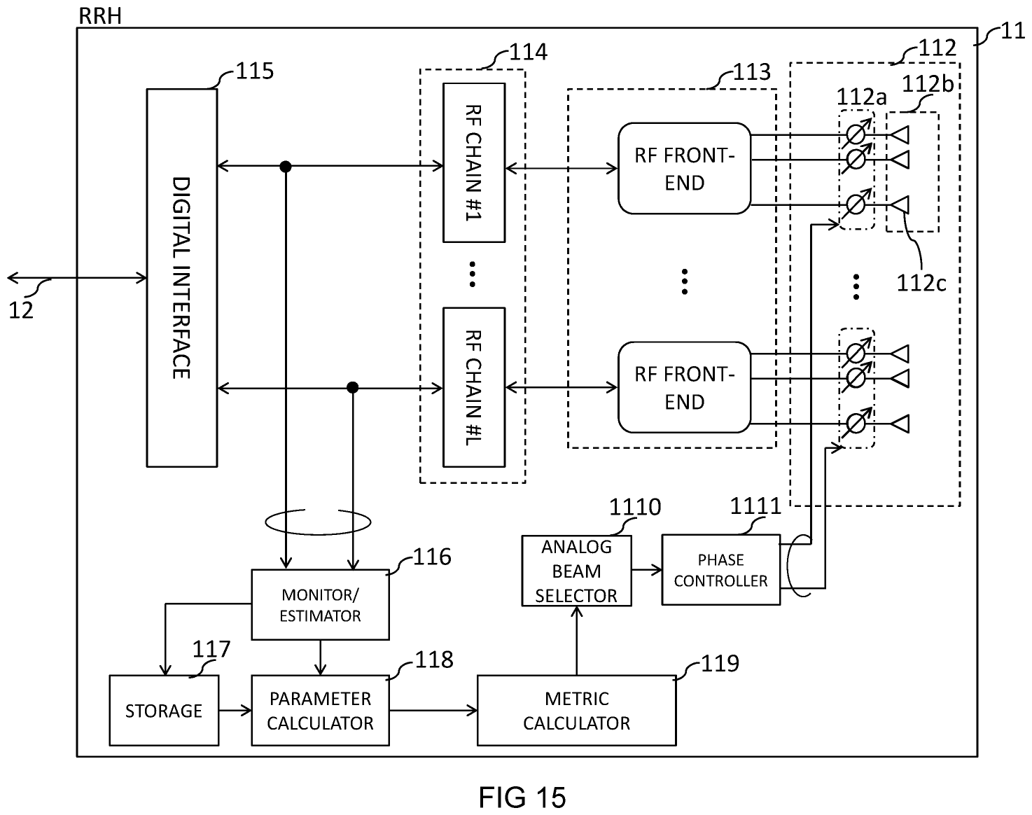

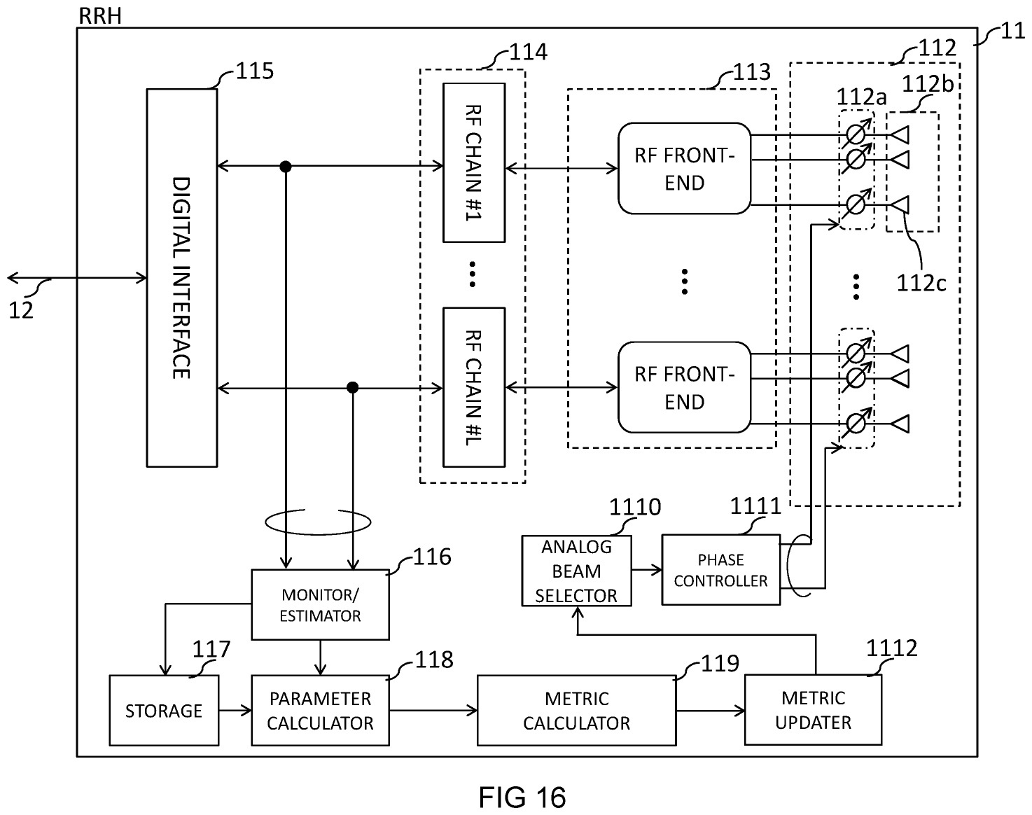

In accordance with one modification in the first and second example embodiments of the present disclosure, the combined monitor/estimator 116 may monitor digital signals flowing between each RF chain 114 and the digital interface 115, continuously or on pre-defined intervals. More specifically, for calculation of parameter(s), representing characteristics of each spatial direction in both uplink and downlink, the combined monitor/estimator 116 monitors digital signals flowing from the digital interface 115 to each RF chain 114 in downlink and from each RF chain 114 to the digital interface 115 in uplink, as shown in FIGS. 15 and 16 for the first example embodiment and second example embodiment, respectively. One such parameter representing the characteristics of each spatial direction can be obtained by calculating the power levels P_{b}. By using mathematical notations in the related art of mobile communication system, the calculated powers from the digital signals of the RF chain #1 (1th RF chain 114) in uplink and downlink can be expressed by following mathematical notations, respectively;

$$\begin{matrix}{P}_{b , UL}^{l} ( i ) = \frac{1}{{N}_{UL}} {\sum }_{n = {n}_{i , UL}}^{{n}_{i , UL} + {N}_{UL} - 1} {( {I}_{b , UL}^{l} ( n ) )}^{2} + {( {Q}_{b , UL}^{l} ( n ) )}^{2} & [ Math .4 ] \\ {P}_{b , DL}^{l} ( j ) = \frac{1}{{N}_{DL}} {\sum }_{n = {n}_{j , DL}}^{{n}_{j , DL} + {N}_{DL} - 1} {( {I}_{b , DL}^{l} ( n ) )}^{2} + {( {Q}_{b , DL}^{l} ( n ) )}^{2} & [ Math .5 ]\end{matrix}$$

Where, P_{b,UL}^{l}(i) and P_{b,DL}^{l}(j) represent the calculated power levels from the digital signals of analog beamforming in the spatial direction b for l^{th} sub-array in i^{th} uplink time-slot and j^{th} downlink time-slot, respectively. I_{b,UL}^{l}(n) and Q_{b,UL}^{l}(n) are in-phase and quadrature phase components of the uplink digital signal of the RF chain #1 at the time instant n, in spatial direction b. Similarly,
I_{b,UL}^{l}(n) and Q_{b,DL}^{l}(n) are the in-phase and quadrature phase components of the downlink digital signal of the RF chain #1 at the time instant n, in spatial direction b. Finally, n_{i,UL} and n_{j,DL} represent a starting index of i^{th} uplink time-slot 411 and j^{th} downlink time-slot 421, respectively as shown in FIG. 9.

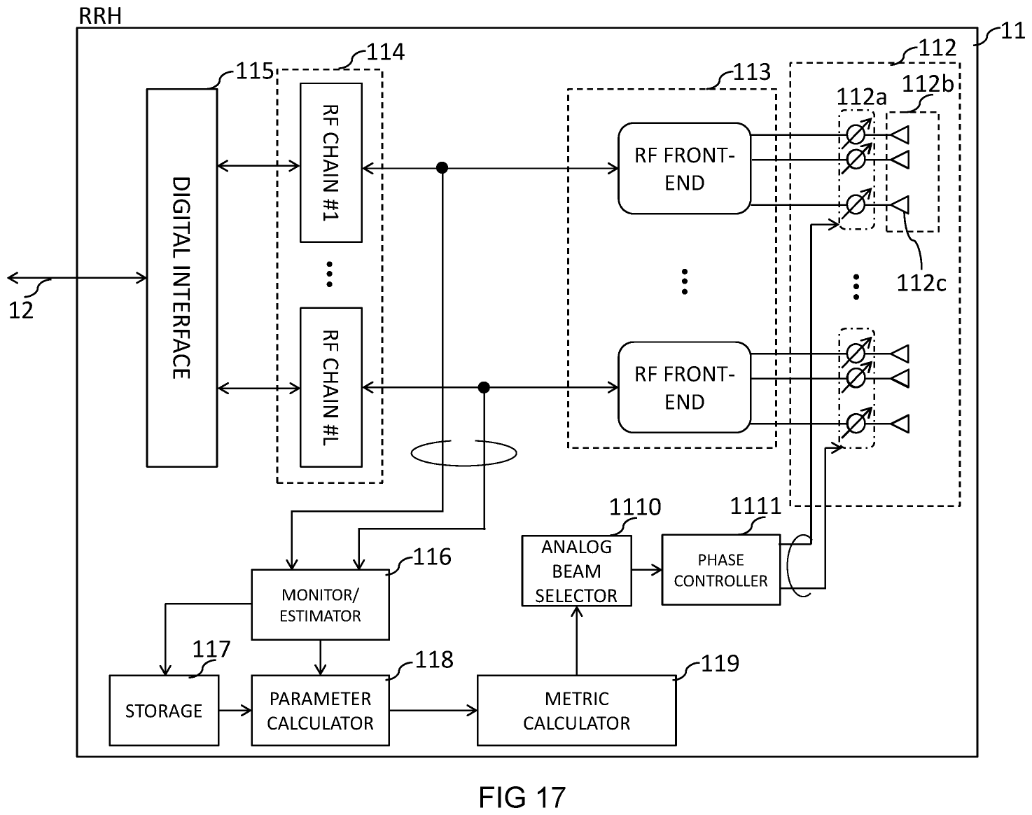

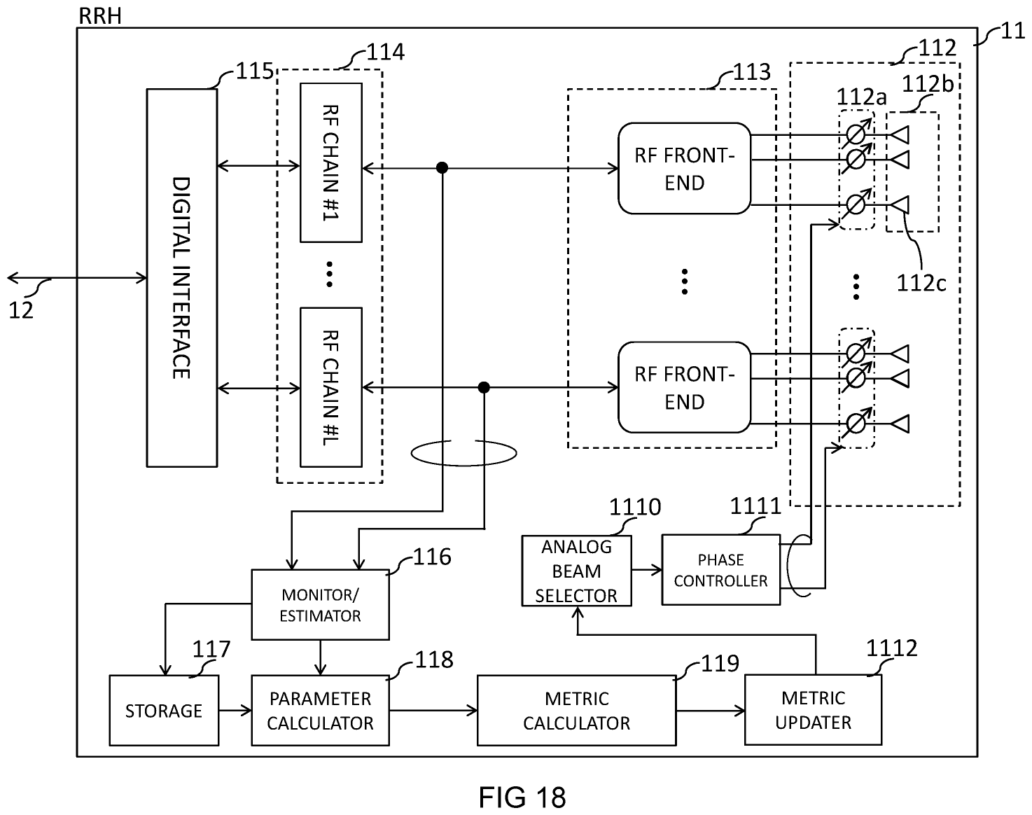

In accordance with another modification in the first and second example embodiments of the present disclosure, the combined monitor/estimator 116 may monitor the analog signals flowing between each RF chain 114 and the RF front-end 113. More specifically, for the calculation of parameter(s) representing characteristics of each spatial direction in both uplink and downlink, the combined monitor/estimator 116 monitors the analog signals flowing from each RF chain 114 to the RF front-end 113 in downlink direction and similarly from each RF front-end 113 to the RF chain 114 in uplink direction, as shown in FIGS. 17 and 18 for the first example embodiment and second example embodiment, respectively.

One such parameter representing the characteristics of each spatial direction can be obtained by calculating the power levels P_{b}. By using the mathematical notations in the related arts of mobile communication system, the calculated power from the analog signals of the RF chain #1 in uplink and downlink can be expressed by following mathematical notations, respectively;

$$\begin{matrix}{P}_{b , UL}^{l} ( i ) = \frac{1}{{T}_{UL}} {\int }_{{t}_{i , UL}}^{{t}_{i , UL} + {T}_{UL}} {\vert {x}_{b , UL}^{l} ( t ) \vert}^{2} dt & [ Math .6 ] \\ {P}_{b , DL}^{l} ( j ) = \frac{1}{{T}_{DL}} {\int }_{{t}_{j , DL}}^{{t}_{j , DL} + {T}_{DL}} {\vert {x}_{b , DL}^{l} ( t ) \vert}^{2} dt & [ Math .7 ]\end{matrix}$$

Where P_{b,UL}^{l}(i) and P_{b,DL}^{l}(j) represent the calculated power levels from the analog signals of analog beamforming in the spatial direction b for l^{th} sub-array in i^{th} uplink time-slot and j^{th} downlink time-slot, respectively. x_{b,UL}^{l}(t) is the analog signal in uplink for the RF chain #1 at time t in spatial direction b. Similarly, x_{b,DL}^{l}(t) is the analog signal in downlink for the RF chain #1 at time t in spatial direction b. T_{UL} and T_{DL} represent duration of one uplink time slot 41 and one downlink time slot 42 in the frame 4, respectively. Finally, t_{i,UL} and t_{j,DL} represent a starting time of i^{th} uplink time-slot 411 and j^{th} downlink time-slot 421, respectively as shown in FIG. 9.

Generally, transmit and/or received analog signals from and/or to the RRH 11 have higher amplitude fluctuations. Another related parameter can be obtained by averaging the calculated power levels over two or more time slots. By using the mathematical notations in the related art of the mobile communication system, the average calculated power from the analog signals of RF chain #1 in uplink and downlink can be expressed by following mathematical notations, respectively;

$$\begin{matrix}{\overline{P}}_{b , UL}^{l} = \frac{1}{{I}_{UL}} {\sum }_{i = 1}^{{I}_{UL}} {P}_{b , UL}^{l} ( i ) & [ Math .8 ] \\ {\overline{P}}_{b , DL}^{l} = \frac{1}{{J}_{DL}} {\sum }_{j = 1}^{{J}_{DL}} {P}_{b , DL}^{l} ( j ) & [ Math .9 ]\end{matrix}$$

Where, P̅_{b,UL}^{l} and P̅_{b,DL}^{l} represent the average power levels in uplink and downlink, respectively. I_{UL} and J_{DL} represent the averaging duration and/or number of time-slots used for averaging in uplink power and downlink power, respectively.

In accordance with another modification in the first and second example embodiments of the present disclosure, the combined monitor/estimator 116 may monitor the analog signals flowing within each RF chain 114. More specifically, for the calculation of parameter(s) representing the characteristics of each spatial direction in both uplink and downlink, the combined monitor/estimator 116 monitors the analog signals within each RF chain 114. For example, the analog signals at an output of DAC 1145 in case downlink data transmission and at an input of ADC 1145 in case uplink data reception. Similarly, from the analog signals that are flowing between any two components of the RF chain 114, as shown in FIG. 10.

In accordance with another modification in the first and second example embodiment of the present disclosure, the combined monitor/estimator 116 may monitor the signal flowing within the radio interface bus 12. More specifically, for the calculation of the parameter(s) representing the characteristics of each spatial direction in both uplink and downlink, the combined monitor/estimator 116 taps the bi-directional radio interface bus 12 which connects the BBU 13 and the RRH 11.

In accordance with another modification in the first and second example embodiment of the present disclosure, the combined monitor/estimator 116 may monitor uplink signals and downlink signals and/or combination of both uplink and downlink signals for the calculation of parameter(s) representing the characteristics of each spatial direction in uplink and downlink. By using the mathematical notations in the related art of the mobile communication system, one such parameter can be calculated by using the power levels calculated from the signals in uplink and downlink and can be expressed by following mathematical notations;

$${P}_{b}^{l} = ( q ) \frac{{P}_{b , UL}^{l}}{{\overline{P}}_{b , UL}^{l}} + ( 1 - q ) \frac{{P}_{b , DL}^{l}}{{\overline{P}}_{b , DL}^{l}} \qquad [ Math .10 ]$$

Where, P_{b}^{l} represents power level in spatial direction b for l^{th} sub-array and q is weighting coefficient, i.e., 0<=q<=1. A value of q can be decided and adjusted adaptively based on system requirements. For maximization of uplink performance (q need to be greater than 0.5; q>0.5), the communication duration is maximized in uplink by aligning the analog beamforming in the direction of higher uplink user density distribution. Similarly, for maximization of the downlink performance (q need to be 0.5 or less; q<=0.5), the communication duration is maximized in downlink by aligning analog beamforming in the direction of higher downlink user density distribution.

Note that the application of the first and second example embodiments is not limited to the parameters and/or metrics used in the previous explanation. On contrary, an essence of the present disclosure can be applied to various scenarios by considering different system configurations, by a skilled person in the art.

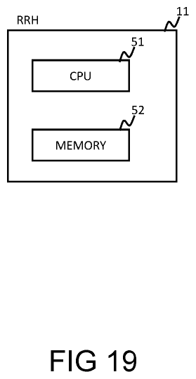

The functions of the RRH 11 (for example, the parameter calculator 118, the metric calculator 119) can be realized by the processor embedded on the RRH 11 (refer to FIG. 19). For example, the RRH 11 includes a CPU (Central Processing Unit) 51 and a memory 52. For example, the processing module such as the parameter calculator 118 can be realized by the CPU 52 that executes a program stored in the memory 52. Further, the program can be updated by downloading the program via a network or a storage medium storing the program.

Preferred modes will now be recited.

### (Mode 1)

Mode 1 is the same as the remote radio head according to the first aspect.

### (Mode 2)

The remote radio head according to Mode 1, further comprising a metric updater configured to update the calculated metric by subtracting a portion of the calculated metric of a selected spatial direction(s).

### (Mode 3)

The remote radio head according to Mode 2, wherein the metric updater is configured to update the calculated metric by subtracting the portion of the calculated metric of adjacent spatial directions to the selected spatial direction(s).

### (Mode 4)

The remote radio head according to Mode 2 or Mode 3, wherein the metric updater is configured to update the metric by subtracting a portion of the calculated metric considering number of RF chains in the system, number of antennas in the system, number of analog beams in the system, or user distribution in the system.

### (Mode 5)

The remote radio head according to any one of Modes 2 to 4, wherein the metric updater is configured to update the metric by averaging over the calculated metric of the adjacent spatial directions.

### (Mode 6)

The remote radio head according to any one of Modes 1 to 5, wherein the parameter calculator is configured to calculate one or more parameters representing characteristics of each the spatial direction as a function of a signal power.

### (Mode 7)

The remote radio head according to any one of Modes 1 to 5, wherein the metric calculator is configured to calculate at least one metric as a function of the calculated parameter(s) using uplink received signals for each the spatial direction of analog beamforming.

### (Mode 8)

The remote radio head according to any one of Modes 1 to 5, wherein the metric calculator is configured to calculate at least one metric as a function of the calculated parameter(s) using downlink transmit signals for each the spatial direction of analog beamforming.

### (Mode 9)

The remote radio head according to any one of Modes 1 to 5, wherein the metric calculator is configured to calculate at least one metric by using at least two parameters representing the un-scanned duration and a power level for each the spatial direction of analog beamforming.

### (Mode 10)

The remote radio head according to any one of Modes 1 to 9, wherein the beam former is configured to generate the analog beams for each time interval based on differences of analog beam directions in subsequent time interval(s).

### (Mode 11)

The remote radio head according to any one of Modes 1 to 10, further comprising:

a storage configured to store the calculated parameter(s) for the each spatial direction; and
a monitor configured to monitor signals of analog beamforming for a current spatial direction(s).

### (Mode 12)

The remote radio head according to Mode 11, wherein

the monitor is configured to monitor digital signals or analog signals.

### (Mode 13)

The remote radio head according to Mode 11 or claim 12, wherein the parameter calculator is configured to calculate at least one parameter by using information monitored by the monitor and information stored in the storage.

### (Mode 14)

Mode 14 is the same as the beamforming method according to the second aspect.

### (Mode 15)

Mode 15 is the same as the storage medium according to the third aspect.

### (Mode 16)

A remote radio head with multiple antennas in a wireless communication system generating a plurality of analog beams to serve at least one user terminal, comprising:

a parameter calculator configured to calculate at least one parameter for each spatial direction;
a metric calculator configured to calculate at least one metric based on the calculated parameter(s) for each the spatial direction;
a metric updater configured to update the metric by subtracting a portion of the calculated metric of the selected spatial direction(s)
a beam former configured to generate analog beams directed towards selected spatial direction(s) according to the metric(s).

### (Mode 17)

The remote radio head according to Mode 16, wherein the metric updater is configured to update the metric by averaging over the calculated metric of the adjacent spatial directions.

### (Mode 18)

The remote radio head according to Mode 16 or Mode 17, wherein the metric updater is configured to update the metric by subtracting a portion of the calculated metric of the adjacent spatial directions to the selected spatial direction(s).

### (Mode 19)

The remote radio head according to Mode 16 to Mode 18, wherein the metric updater is configured to update the metric by subtracting a portion of the calculated metric considering number of RF chains in the system, number of antennas in the system, number of analog beams in the system, or user distribution in the system.

### (Mode 20)

The remote radio head according to any one of Modes 16 to 19, wherein the parameter calculator is configured to calculate one or more parameters representing characteristics of each the spatial direction as a function of un-scanned duration.

### (Mode 21)

The remote radio head according to Mode 16 to 19, wherein the parameter calculator is configured to calculate one or more parameters representing characteristics of each the spatial direction as a function of a signal power.

### (Mode 22)

The remote radio head according to any one of Modes 16 to 19, wherein the metric calculator is configured to calculate at least one metric as a function of the calculated parameter(s) using uplink received signals for each the spatial direction of analog beamforming.

### (Mode 23)

The remote radio head according to any one of Modes 16 to 19, wherein the metric calculator is configured to calculate at least one metric as a function of the calculated parameter(s) using downlink transmit signals for each the spatial direction of analog beamforming.

### (Mode 24)

The remote radio head according to any one of Modes 16 to 23, wherein the beam former is configured to generate the analog beams for each time interval based on differences of analog beam directions in subsequent time interval(s).

### (Mode 25)

The remote radio head according to any one of Modes 16 to 24, further comprising:

a storage configured to store the calculated parameter(s) for the each spatial direction; and
a monitor configured to monitor signals of analog beamforming for a current spatial direction(s).

### (Mode 26)

The remote radio head according to Mode 25, wherein

the monitor is configured to monitor digital signals flowing between a digital interface for a base band unit (BBU) and RF (Radio Frequency) chains.

### (Mode 27)

The remote radio head according to Mode 26, wherein

the monitor is configured to monitor analog signals flowing between RF (Radio Frequency) chains and RF front-ends.

### (Mode 28)

The remote radio head according to any one of Modes 25 to 27, wherein the parameter calculator is configured to calculate at least one parameter by using information monitored by the monitor and information stored in the storage.

### (Mode 29)

A beamforming method performed in a remote radio head with multiple antennas in a wireless communication system generating a plurality of analog beams to serve at least one user terminal, the method comprising:

calculating at least one parameter including an un-scanned duration for each spatial direction;
calculating at least one metric based on the calculated parameter(s) for each the spatial direction;
updating at least one metric based on the calculated metric for each spatial direction; and
generating analog beams directed towards the selected spatial direction(s) according to the average calculated metric(s).

### (Mode 30)

A program executed by a computer embedded on a remote radio head with multiple antennas in a wireless communication system generating a plurality of analog beams to serve at least one user terminal,

the program causes the computer to execute:
calculating at least one parameter including an un-scanned duration for each spatial direction;
calculating at least one metric based on the calculated parameter(s) for each the spatial direction;
updating at least one metric based on the calculated metric for each spatial direction; and
generating analog beams directed towards the selected spatial direction(s) according to the average calculated metric(s).

The disclosure of Patent Literature given above is hereby incorporated by reference into this specification. The example embodiments may be changed and adjusted within the aspect of the entire disclosure (including claims) of the present invention and based on the basic technological concept. Within the scope of the claims of the present invention, various disclosed elements may be combined and selected in a variety of ways. That is, it is to be understood that modifications, changes as well as selections and combinations of elements that may be made by those skilled in the art within the entire disclosure of the present invention are requested to be included.

1. A remote radio head comprising
a plurality of antennas in a wireless communication system generating a plurality of analog beams to serve at least one user terminal, comprising:
a parameter calculator that calculates at least one parameter including an un-scanned duration for each spatial direction;
a metric calculator that calculates at least one metric based on the calculated parameter for each the spatial direction; and
a beam former that generates analog beams directed towards a spatial direction according to the calculated metric.

2. The remote radio head according to claim 1, further comprising
a metric updater that updates the calculated metric by subtracting a portion of the calculated metric of a selected spatial direction.

3. The remote radio head according to claim 2, wherein
the metric updater is updates the calculated metric by subtracting the portion of the calculated metric of adjacent spatial directions to the selected spatial direction.

4. The remote radio head according to claim 2, wherein
the metric updater is updates the metric by subtracting a portion of the calculated metric considering number of RF chains in the system, number of antennas in the system, number of analog beams in the system, or user distribution in the system.

5. The remote radio head according to claim 2, wherein
the metric updater updates the metric by averaging over the calculated metric of the adjacent spatial directions.

6. The remote radio head according to claim 1, wherein
the parameter calculator calculates one or more parameters representing characteristics of each the spatial direction as a function of a signal power.

7. The remote radio head according to claim 1, wherein
the metric calculator calculates at least one metric as a function of the calculated parameter using uplink received signals for each the spatial direction of analog beamforming.

8. The remote radio head according to claim 1, wherein
the metric calculator calculates at least one metric as a function of the calculated parameter using downlink transmit signals for each the spatial direction of analog beamforming.

9. The remote radio head according to claim 1, wherein
the metric calculator calculates at least one metric by using at least two parameters representing the un-scanned duration and a power level for each the spatial direction of analog beamforming.

10. The remote radio head according to claim 1, wherein
the beam former generates the analog beams for each time interval based on differences of analog beam directions in a subsequent time interval.

11. The remote radio head according to claim 1, further comprising:
a storage that stores the calculated parameter for the each spatial direction; and
a monitor that monitors signals of analog beamforming for a current spatial direction.

12. The remote radio head according to claim 11, wherein
the monitor monitors digital signals or analog signals.

13. The remote radio head according to claim 11, wherein
the parameter calculator calculates at least one parameter by using information monitored by the monitor and information stored in the storage.

14. A beamforming method performed in a remote radio head with multiple antennas in a wireless communication system generating a plurality of analog beams to serve at least one user terminal,
the method comprising:
calculating at least one parameter including an un-scanned duration for each spatial direction;
calculating at least one metric based on the calculated parameter for each the spatial direction; and
generating analog beams directed towards a spatial direction according to the calculated metric

15. A non-transitory computer readable storage medium storing a program executed by a computer embedded on a remote radio head with multiple antennas in a wireless communication system generating a plurality of analog beams to serve at least one user terminal,
the program causes the computer to execute:
calculating at least one parameter including an un-scanned duration for each spatial direction;
calculating at least one metric based on the calculated parameter for each the spatial direction; and
generating analog beams directed towards a spatial direction according to the calculated metric.

16. The remote radio head according to claim 1, wherein
the metric calculator calculates the metric to optimize a communication duration in a spatial direction with a user density distribution higher than a predetermined value and avoid miss-detection of a new emerging user in other spatial direction.

17. The remote radio head according to claim 2, wherein
the metric updater updates the calculated metric by subtracting a fraction of the metric in the adjacent analog beams used for calculation of an average metric of the selected spatial direction.

18. The remote radio head according to claim 9, wherein
the metric calculator calculates an objective function representing the metric having, as input variables, the un-scanned duration and the signal power level in each of the spatial directions and selects a predetermined number of spatial directions based on the metrics calculated for the spatial directions, wherein
the beam former steers analog beams in the predetermined number of spatial directions using beam forming weights.

19. The remote radio head according to claim 5, wherein
the metric updater updates the calculated metric by calculating the average metric for each the spatial direction by averaging the calculated metrics over a plurality of adjacent spatial directions of analog beamforming for uplink and downlink, and selecting a spatial direction with a highest value out of a plurality of the average metrics.

20. The remote radio head according to claim 1, wherein
the plurality of antennas includes
a plurality of sub-arrays into which the plurality of antennas are grouped; and
a plurality of groups of phase shifters, each of the groups of phase shifters connected to each of the sub-arrays of antennas,
wherein the remote radio head further comprises:
a plurality of Radio Frequency (RF) chains;
a plurality of Radio Frequency (RF) front ends, each of the RF front ends connected to each of the plurality of RF chains, and connected via each of the groups of phase shifters to each of the sub-arrays of antennas; and
a digital interface that performs at least one of transmission and reception of a digital signal to and from the plurality of RF chains, wherein the beam former controls at least phase shift in the groups of phase shifters to steer the analog beams in the spatial direction, based on the calculated at least one metric.
